(19) United States
(12) Patent Application Publication
(10) Pub. No.: US 2004/0017272 A1
(43) Pub. Date: Jan. 29, 2004

(54) Low cost dielectric tuning for E-plane filters

(76) Inventors: Stephanie L. Smith, Marsfield (AU); Shaun J. Cunningham, Lane Cove (AU)

Correspondence Address: NIXON & VANDERHYE, PC, 1100 N GLEBE ROAD, 8TH FLOOR, ARLINGTON, VA, 22201-4714, US

(21) Appl. No.: 10/368,005

(22) Filed: Feb. 19, 2003

(30) Foreign Application Priority Data
Feb. 19, 2002 (AU) PS0618

(51) Int. Cl. H01P 1/208

(52) U.S. Cl. 333/209; 333/212

(57) ABSTRACT

The requirements of wider bandwidths for communication systems and the resultant use of the millimetre wave region are discussed. The tolerances of filter components for use in the millimetre wave region have required costly manufacturing. E-plane filters (400), a tuning element (450) for such a filter (400), and methods of making and tuning such a filter (400) are disclosed. In particular, the manufacturing (and tuning) technique allows filters (400) of this type to be used at higher frequencies without the need for using higher precision, high cost manufacturing techniques. The filter (400) has at least two waveguide members (410A, 410B) and at least one septum (430) disposed in a waveguide cavity (420) formed by the assembled waveguide members (410A, 410B). The characteristics of the filter (400) are tested. A dielectric tuning member (450) is then inserted into the waveguide cavity (420) of the assembled filter (400) to adjust at least one frequency characteristic of the filter (400) dependent upon the tested filter characteristics.

### FIELD OF THE INVENTION

The present invention relates generally to E-plane filters, and in particular to E-plane filters for use in millimeter-wave bands and methods of manufacturing, tuning, and using the same.

### BACKGROUND

Communication systems are requiring wider bandwidths all the time, and the millimetre wave region is needed to achieve these wide bandwidths. Further, such communication systems need filters to eliminate interference between adjacent bands. Waveguide filters are generally used for millimetre wave applications due to their relatively low loss. Of all the different types of waveguide filters, the E-plane or finline filter is the most suitable at higher frequencies due to its ease of manufacture and its straightforward physical structure being suitable for high-precision mass manufacture.

In particular, mobile communication systems of the future are required to support high data rate services such as mobile Internet. Fourth and fifth generation mobile communication systems will include cellular phones, broadband wireless access systems, millimeter-wave LANs and intelligent transport systems: S. Ohmori, Y. Yamao and N. Nakajima, “The future generations of mobile communications based on broadband access technologies,” IEEE Communications Magazine, pp. 134-142, December 2000. To achieve these broadband services, the frequency of operation is increasing, and most of these services will likely be operating in the millimeter-wave region. To develop these systems, a need exists for low-cost, mass-producible components.

While E-plane filters are widely used at millimetre frequencies, tight tolerances are required to achieve a filter response close enough to the desired response to avoid tuning. The manufacturing techniques needed to achieve such tight tolerances are costly. As the frequency of operation is increased, the tolerances need to be tightened even further to avoid tuning the response. A frequency is reached where the manufacturing tolerances required cannot be achieved to avoid tuning. Either different filtering techniques are required, or it becomes necessary to introduce some tuning methods. Relevant tuning methods suitable at millimetre-wave frequency bands include:

1) tuning screws,

2) movable walls in a waveguide, and

3) dielectric materials having properties that can be changed by applying a voltage across the dielectric.

Tuning screws are generally inserted into the waveguide in the centre of each resonator and each coupling region. A manual or automated iterative process is then used to adjust the resonant frequency of each resonator and the coupling between resonators. Harscher, P. and Vahldieck, R, “Automated computer-controlled tuning of waveguide filters using adaptive network models,” IEEE Trans. Microwave Theory Tech., vol. 49, no. 11, pp. 2125-2130, 2001, presents an automated approach in which the tuning screws are turned by stepper motors and controlled by a computer, which adjusts the tuning screws using a tuning algorithm until the desired response is obtained. Both the manual and automated tuning process require the additional expense of accurately threaded holes in the waveguide body for the tuning screws. Both also require the extra assembly step of inserting the tuning screws into the waveguide. The tuning process is very sensitive, making it costly and difficult to tune and assemble. Further to these points, the manual technique requires a skilled operator to tune the filter.

A movable dielectric wall inside the waveguide has been used to tune E-plane metal-septum and dielectric finline filters by changing the cutoff frequency of the waveguide. This in turn changes the centre frequency of the filter response. See U.S. Pat. No. 4,761,625, entitled “Tunable waveguide bandpass filter,” which issued to Sharma on Aug. 2, 1988. A dielectric plate is inserted parallel to the septum inside the waveguide, and the plate is moved toward or away from the septum to tune the centre frequency of the filter response. This technique is used mainly to enable one filter design to cover a number of bands, where the desired band is selected by positioning the dielectric plate. This technique cannot be used to correct the filter response, only to translate the response. The assembly is very complicated and the dielectric wall has to be moved manually to the position that gives the correct frequency response.

Paratek Microwave, Inc, “Electronically tunable RF filters for LMDS frequencies,” Microwave Journal, May 2000 have a range of electronically tunable RF E-plane filters covering the lower millimetre wave region. These filters use a ceramic material having properties that can be altered with a changing bias voltage, which in turn changes the filter response. This requires a stable, high DC voltage supply to adjust the dielectric constant, which complicates the filter structure and is very costly. Further, if this technique were to be used to tune individual resonator and coupling sections, a different voltage may be required for each resonator or coupling element.

Thus, a need clearly exists for a less costly, simpler technique for tuning E-plane filters.

### SUMMARY

In accordance with a first aspect of the invention, a method of tuning an E-plane waveguide filter is provided. The method includes the steps of: testing filter characteristics of the filter, the filter including at least two waveguide members and at least one septum assembled together, each waveguide member having a shaped surface formed in the waveguide member to provide a waveguide cavity when the waveguide members are assembled, the at least one septum disposed in the waveguide cavity, and inserting a dielectric tuning member into the waveguide cavity of the assembled filter to adjust at least one frequency characteristic of the filter dependent upon the tested filter characteristics.

In accordance with a second aspect of the invention, a method of making an E-plane waveguide filter is provided. At least two waveguide members are assembled with at least one septum in a waveguide cavity. Each waveguide member has a shaped surface formed in the waveguide member to provide the waveguide cavity when the waveguide members are assembled. A dielectric tuning member is inserted into the waveguide cavity to adjust at least one frequency characteristic of the filter for the assembled waveguide members and at least one septum.

In accordance with a third aspect of the invention, an E-plane waveguide filter is provided. The filter includes at least two waveguide members and at least one septum. Each waveguide member has a shaped surface formed in the waveguide member to provide a waveguide cavity when the waveguide members are assembled. The at least one septum is located in the waveguide cavity A dielectric tuning member is inserted in the waveguide cavity of the assembled filter to adjust at least one frequency characteristic of the filter dependent upon tested filter characteristics.

In accordance with a fourth aspect of the invention, a tuning member for an E-plane wave guide filter is provided. The filter includes at least two waveguide members and at least one septum. Each waveguide member has a shaped surface formed in the waveguide member to provide a waveguide cavity when the waveguide members are assembled. The at least one septum is disposed in the waveguide cavity. The tuning member includes a dielectric member for adjusting at least one frequency characteristic of the filter when inserted into the waveguide cavity. The dielectric member is formed in response to tested frequency characteristics of the filter for the assembled waveguide members and at least one septum.

### BRIEF DESCRIPTION OF THE DRAWINGS

A small number of embodiments of the invention are described hereinafter with reference to the drawings, in which:

FIG. 1 is a perspective view of a two-piece, die-cast waveguide;

FIG. 2 is a graph illustrating waveguide wavelength versus free space wavelength for a range of draft angles,

FIG. 3 is a perspective view of another two-piece wave guide with a septum in the waveguide cavity and the waveguide further shown in plan view;

FIGS. 4A, 4B, and 4C are perspective views of an assembled E-plane waveguide filter with a tuning element, the angled tuning element itself, and the waveguide filter arranged in an exploded manner, respectively, in accordance with a first embodiment of the invention,

FIGS. 5A, 5B, and 5C are perspective views of an assembled E-plane waveguide filter with a tuning element, the flat, rectangular tuning element itself, and the waveguide filter arranged in an exploded manner, respectively, in accordance with a second embodiment of the invention;

FIGS. 6A, 6B, and 6C are perspective views of an assembled E-plane waveguide filter with a tuning element, the rectangular U-shaped tuning element itself, and the waveguide filter arranged in an exploded manner, respectively, in accordance with a third embodiment of the invention;

FIGS. 7A, 7B, and 7C are perspective views of an assembled E-plane waveguide filter with a tuning element, the U-shaped-with-flanges tuning element itself, and the waveguide filter arranged in an exploded manner, respectively, in accordance with a fourth embodiment of the invention;

FIGS. 8A, 8B, and 8C are perspective views of an assembled E-plane waveguide filter with tuning element, the curved U-shaped tuning element itself, and the waveguide filter arranged in an exploded manner, respectively, in accordance with a fifth embodiment of the invention;

FIGS. 9A, 9B, and 9C are perspective views of an assembled E-plane waveguide filter with tuning element, the L-shaped tuning element itself, and the waveguide filter arranged in an exploded manner, respectively, in accordance with a sixth embodiment of the invention;

FIG. 10 is a perspective view of the dielectric tuning element of FIG. 5 with various apertures and re-entrant features demonstrating how the dielectric may be patterned in accordance with a further embodiment;

FIG. 11 is a graph illustrating the measured filter response prior to tuning compared with the modelled filter response; and

FIG. 12 is a graph illustrating the measured filter response after tuning compared with an ideal modelled response.

### DETAILED DESCRIPTION

An E-plane waveguide filter used in millimeter-wave bands, a tuning element for such an E-plane waveguide filter, and methods of making and tuning an E-plane waveguide filter used in millimeter-wave bands are disclosed. In the following description, numerous details are set forth including particular metals for patterning, particular waveguide materials, plastic such as polyethylene as dielectric materials, numbers of waveguide filter members, cross-sectional, waveguide-cavity shapes, numbers of septa, the use and nature of tabs and apertures in the tuning element, and the like. However, it will be apparent to those skilled in the art that changes and/or modifications can be made without departing from the scope and spirit of the invention.

I. Overview

In accordance with the embodiments of the invention, an E-plane millimeter-wave filter using waveguide can be manufactured using lowermost, less stringent techniques in terms of tolerances, and then the desired filter response can be obtained using a simple, low-cost tuning element. Preferably, waveguide filter members are fabricated using lower-cost die-casting. This is in contrast to more stringent fabrication techniques such as machining. However, it will be apparent to those skilled in the art in the light of the disclosure herein that the advantages of the dielectric tuning element and technique in accordance with the embodiments make it suitable for application to waveguide filter members that are machined or similarly fabricated without departing from the scope and spirit of the invention

The problem with casting at millimetre wave frequencies is the higher manufacturing tolerances. However, the embodiments of the invention permit and enable a precision casting technique to be used that results to make the waveguide filter members in reasonable tolerances. The filter response can then be tuned for a total filter cost lower than that of the higher precision manufacturing techniques. Further, the dielectric tuning technique in accordance with the embodiments of the invention can be used at even higher frequencies, where even high precision manufacturing techniques may not provide suitably accurate filter responses.

The dielectric tuning technique according to the embodiments of the invention involves, after the filter has been assembled and the filter response has been initially measured, inserting a dielectric (plastic) member into a waveguide filter. This technique can be used to tune the centre frequency of the filter response by changing the cutoff frequency of the waveguide. Further, the tuning technique can be used to tune individual resonator and coupling elements. The former use is achieved by inserting a uniform piece of dielectric into the guide, and the latter use is achieved by inserting an appropriately patterned piece of dielectric into the guide.

As noted earlier, the waveguide filter is assembled (i.e. two or more waveguide filter elements and one or more septa), and the filter response is initially measured. The details of the measured filter response can be entered into a computer, which also contains information about the desired filter response. Patterning on the piece of dielectric (i.e., the tuning element) is calculated using the computer such that the desired filter response is obtained in light of the measured filter response. The patterning on the tuning element, or dielectric body, is performed preferably using an automated punching device. The (plastic) tuning element is then inserted into the waveguide filter without the filter being de-assembled. The filter response is measured finally to check that the filter response meets specifications. This technique is extremely cost effective as the actual tuning technique is filly automated and little manual intervention is required.

In the embodiments of the invention, a waveguide filter includes at least two hollow waveguide members separated along the centre of a broad dimension of the waveguide. At least one septum is inserted between the waveguide members in the waveguide cavity. The septum may be metal with windows forming resonant filter cavities, or alternatively the septum may be dielectric with patterned metal to form resonant cavities and coupling sections, i.e. finline. After measurement of the assembled waveguide filter, a dielectric tuning element is inserted into the waveguide, where the dielectric tuning element may be patterned. Examples of relevant dielectric materials include plastic, such as polyethylene. The dielectric materials may be of several thicknesses, and be stamped or patterned.

When designing the waveguide filter, the maximum frequency shift ±Δf₀ that may occur due to manufacturing tolerances must be known. A frequency shift of 2% of f₀ is typically achievable with the tuning technique according to the embodiments of the invention. The filter must then be designed at f₀+Δf₀, because the dielectric tuning techniques only shift down the frequency response of the filter. With tolerances then, the centre frequency of the filter response should roughly vary between f₀ and f₀+2Δf₀, and filters having centre frequencies that are greater than f₀ can be tuned using the dielectric tuning technique.

The embodiments of the invention may be practiced with relevant filters having any number of septa (e.g., 1, 2, 3, or more septa). Further, references to septa herein include finline structures, where the septum is patterned metal on a dielectric insert (i.e., the septum is a circuit-board-like structure).

II. E-Plane Waveguide Filters

While the embodiments of the invention are not limited to waveguide elements made in accordance with a particular fabrication technique, the embodiments of the invention have particular application to such elements fabricated using die-casting.

For filters in the millimeter-wave bands, performance is of paramount importance. To achieve the required performance, ever improving, low-tolerance manufacturing techniques are required. It is difficult to find a low-cost manufacturing technique with suitable tolerances for millimeter-wave applications. However, as frequency increases further, even the highest precision, high-cost manufacturing techniques do not satisfy the performance requirements of these filters, and so there is a trade-off between high-cost, high precision and low-cost, low precision with the need for tuning.

A less precise manufacturing technique along with a low-cost tuning technique, both of which are suitable for mass-production, enable lower-cost manufacturing of these filters. Using this approach, the cost of existing higher precision manufacturing techniques may be halved. In some applications, performance may be traded off for cost. Preferably, the waveguide portions of the filter are manufactured using a die-casting process, and the septum is made using fineblanking. However, a number of low cost methods of manufacturing the septum exist. The required tolerances on the critical dimensions of the septum are described hereinafter.

Die-casting is the process of forcing molten metal into metal dies. The die is made using high-precision machining, hardening and grinding techniques usually for production rates of greater than 10,000 pieces. Fineblanking is a combination of stamping and cold extrusion, giving a more accurate and cleaner finish than stamping. The post-assembly tuning process of the invention does not require individual tuning screws of conventional tuning techniques.

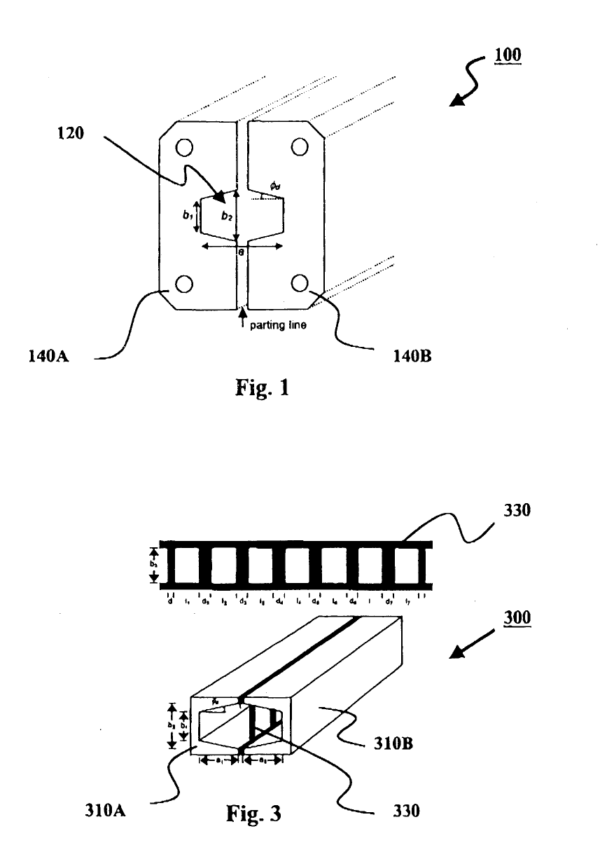

For ease of removal of a waveguide piece from a die and to keep the cost of manufacture to a minimum, a draft angle φ_{d} is required on all surfaces that are perpendicular to the parting line. FIG. 1 illustrates two pieces 140A and 140B of a die-cast waveguide 100. The two halves or pieces 140A and 140B form a waveguide cavity 120 when assembled. The cross-sectional waveguide cavity shape is substantially rectangular or hexagonal in the drawings. However, it will be apparent to those skilled in the art, that other shapes may be practiced without departing from the scope and spirit of the invention. A draft angle φ_{d} of at least 2° is generally required. The waveguide cross-section dimensions b₁ and b₂ are calculated so that the cross-sectional area of the wave guide with draft angles is equal to the cross sectional area of a standard rectangular waveguide. This results in the smallest mismatch when connecting a standard waveguide to a waveguide with a draft angle φ_{d}.

The addition of a draft angle results in a decrease in the cut-off wavelength (λ_{c}) of the waveguide over that in a standard rectangular guide, the amount of which is dependent on the size of the draft angle. Table I lists the cut-off wavelength for a number of draft angles compared with standard WR34 rectangular waveguide. The values were obtained from HFSS (Ansoft Corporation, “HFSS Version 8.0.25,” USA, 2001.)

TABLE I
λ_{c} FOR A NUMBER OF DRAFT ANGLES

| φ_{d} (°) | λ_{c} (mm) |
|---|---|
| 0 | 17.289 |
| 1.5 | 17.110 |
| 2.0 | 17.051 |
| 2.5 | 16.992 |
| 3.0 | 16.934 |

From Table I, the waveguide wavelength (λ_{g}) can be calculated:

$${λ}_{g} = \frac{{λ}_{o}}{\sqrt{1 - \frac{{λ}_{o}^{2}}{{λ}_{c}^{2}}}} \qquad ( 1 )$$

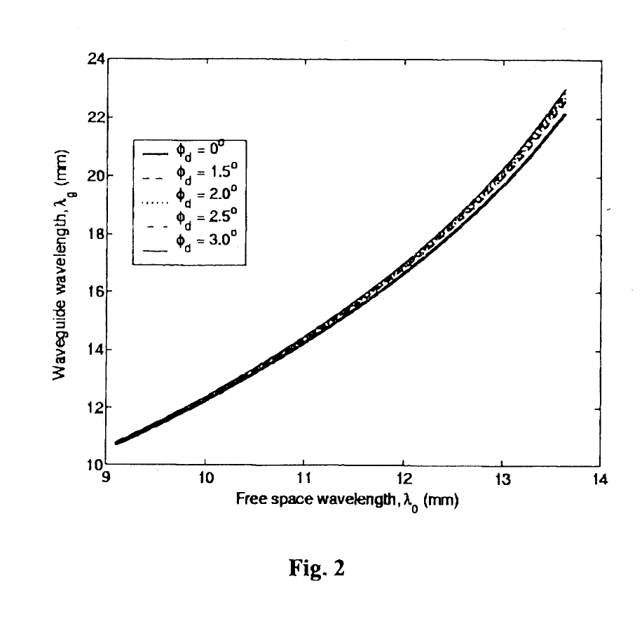

FIG. 2 is a graph of the waveguide wavelength λ_{g} (mm) verses free space wavelength (λ₀) for a range of draft angles, λ_{d} (°) given in Table I. FIG. 2 shows that the reduced cut-off wavelength results in an increase in the waveguide wavelength and also a change in the shape of the waveguide wavelength verses free space wavelength curve. FIG. 2 covers the entire WR34 waveguide band and shows that at lower frequencies, the change can be quite large. This affects the response of a waveguide filter, and so must be accounted for during the design.

With reference to FIG. 2, the overall effect on the response of a filter is the same for each draft angle, and that is to increase the center frequency of the filter over that in a standard waveguide, while scaling the % bandwidth accordingly. The simplest method to account for this is to design and optimize the filter in standard rectangular waveguide at a correspondingly lower frequency such that after the addition of the draft angles, the center frequency is correct.

By way of example only, if a filter is required with a center frequency of 28 GHz, a 3% bandwidth and a draft angle φ_{d} of 3°, Equation (1) can be used to calculate the scaled center frequency to be used for the filter design. With no draft angle, λ_{c}=17.289 mm, at 28 GHz λ₀=10.7143 mm and (1) gives λ_{g}=13.6518 mm. To calculate the scaled center frequency, the frequency in the waveguide with 3° draft angle at which the waveguide wavelength is the same as in rectangular waveguide must be found. With a 3° draft angle, λ_{c}=16.934 mm, λ_{g}=13.6518 mm and from (1) λ₀=10.6282 mm. This equates to a scaled center frequency of 28.227 GHz, which is an increase of 0.811% over standard rectangular guide. The filter can thus be designed and optimized using conventional software such as that based on the mode matching method (see J. Uher, J. Bornemann and U. Rosenberg, “Waveguide components for antenna feed systems: Theory and CAD”, Boston: Artech House, Chapter 2.1 at pp. 9-42, 1993) with a center frequency of 27.775 GHz, which will scale to 28 GHz when the 3° draft angle is added. The foregoing is provided for purposes of illustration only. It will be apparent to those skilled in the art in view of this disclosure that the embodiments of the invention are not limited to these parameters and values, and changes and/or modifications may be made without departing from the scope and spirit of the invention.

FIG. 3 shows a seven-section E-plane filter 300 designed with a passband center frequency of 27.925 GHz and a 3.044% bandwidth (27.5-28.35 GHz) in WR34 with which embodiments of the invention may be practiced. The filter 300 has two waveguide halves or members 310A and 310B and a seven-section septum 330. The filter 330 is designed and optimized using a mode matching technique with a scaled center frequency of 27.698 GHz, which scales to 27.925 GHz when a 2.5° draft angle is added. The optimized filter dimensions are: a1=a2=4.218 mm; b1=4.1338 mm, b2=4.5022 mm; t=0.200 mm; d1=d8=0.4869 mm, d2=d7=3.1981 mm, d3=d6=4.4065 mm, d4=d5=4.7714 mm; l1=l7=4.8871 mm, l2=l6=4.9257 mm, l3=l5=4.9240 mm, l4=4.9235 mm; and φ_{d}=2.5°.

III. Manufacturing Issues of E-Plane Waveguide Filters

Commonly, a guard band of between 3-5% is included in the design of a filter to allow for frequency shift caused by manufacturing tolerances. For the foregoing described E-plane filter, a guard band is not included, but the maximum allocated is 50 MHz at either edge of the passband. The critical physical dimensions of this filter are:

the width of the waveguide halves a₁, a₂,

the septum thickness t and

the draft angle φ_{d}.

These three critical dimensions affect the filter response by shifting the center frequency, but do not alter the filter response by changing pole positions. Random changes in the dimensions d₁-d₈ and l₁-l₇ shown in FIG. 3 change pole positions.

A high precision, mass manufacturing technique, such as machining, normally has a tolerance of ±10 μm the critical dimensions. It is not possible to improve this tolerance considerably without also increasing the cost considerably. For the foregoing described E-plane filter, with no draft angle φ_{d} as is the case with a machined part, a change in the width of the waveguide of ±10 μm results in a shift in the center frequency of the filter of ∓40 MHz. If the tolerance on the thickness of the septum is ±20 μm for a 200 μm thick stainless steel septum, a change in the thickness of the septum of ±20 μm results in a shift in the center frequency of the filter of ±60 MHz. Reducing the thickness of the septum can reduce the tolerance on the septum thickness. For example, the tolerance of 100 μm thick stainless steel is ±10 μm and for 50 μm thick stainless steel is ±7.5 μm. With a septum thickness of 50 μm and a tolerance on the thickness of ±7.5 μm, the frequency shift in the centre frequency of the filter is ±25 MHz.

With the width of the waveguide halves 310A, 310B varying by ±10 μm and the thickness of the septum varying by ±7.5 μm, the centre frequency of the filter may vary by up to ±65 MHz. This is greater than the 50 MHz guard band that is acceptable and does not include other smaller frequency variations due to random changes in the dimensions d₁-d₈ and l₁-l₇. The lowest tolerances currently available on the critical dimensions are not acceptable, even at the lower millimetre wave frequencies. These filters therefore require tuning of some kind to ensure the frequency of operation is within the specified limits. The embodiments of the invention enable a much lower cost manufacturing technique to be used that still provides an accurate filter response but that may have a frequency offset, which can be simply tuned.

The waveguide halves 310A, 310B can be manufactured using a die-casting process with an accuracy of ±15 μm on the critical dimensions, and ±0.25° on the draft angle. The tolerance of ±15 μm on the width of the waveguide halves 310A, 310B results in a maximum shift in the centre frequency of the filter of ∓60 MHz. A change in the thickness of the septum of ±20 μm results in a shift in the centre frequency of ±60 MHz, and a change in the draft angle of ±0.25° results in a shift in the centre frequency of ±15 MHz. The maximum combined effect is a frequency shift of +135 MHz when the width of the waveguide is −15 μm, the thickness of the septum is +20 μm and the draft angle is +0.25°. Alternatively, the maximum combined effect is a frequency shift of −135 MHz when the width of the waveguide is +15 μm, the thickness of the septum is −20 μm and the draft angle is −0.25°. With a 50 μm thick septum and a tolerance of ±7.5 μm on the thickness, the centre frequency of the filter is shifted by up to ±25 MHz. The maximum combined effect with the 50 μm thick septum is a frequency shift of ±100 MHz. A tolerance of ±15 μm on the critical dimensions of the septum is sufficient at 28 GHz to ensure the return loss of the filter is greater than 20 dB across the filter bandwidth.

The E-plane filter 300 is manufactured from die cast zinc (Zamak #3) with a 2.5° draft angle, tolerances of ±15 μm on the critical dimensions, and ±50 μm across the length of the waveguide. The septum is manufactured from 200 μm thick stainless steel with a tolerance of ±20 μm on the thickness, ±15 μm on the critical dimensions, and ±25 μm across the length of the septum. The septum was copper plated after manufacture.

The filter was modelled on HFSS using a conductivity of 1.6e7 S/m for the zinc waveguide halves and 5.8e7 S/m for the copper plated stainless steel septum. The conductivity of copper was sufficient for modelling the septum due to the skin depth being less than the plating thickness of the copper.

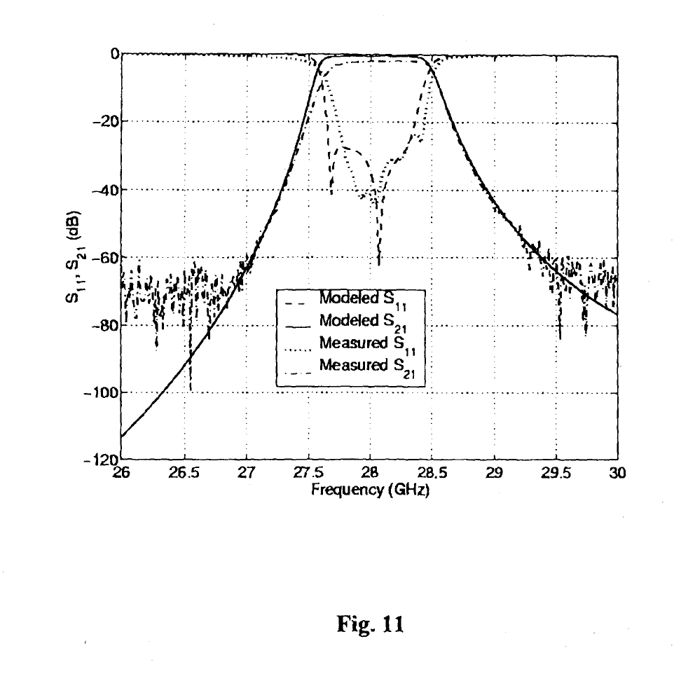

The measured filter response with no tuning is shown in FIG. 11 compared with the modelled response from HFSS. This shows that, as expected there has been a considerable frequency shift (+140 MHz), but the shape of the filter response is quite close to the modelled response.

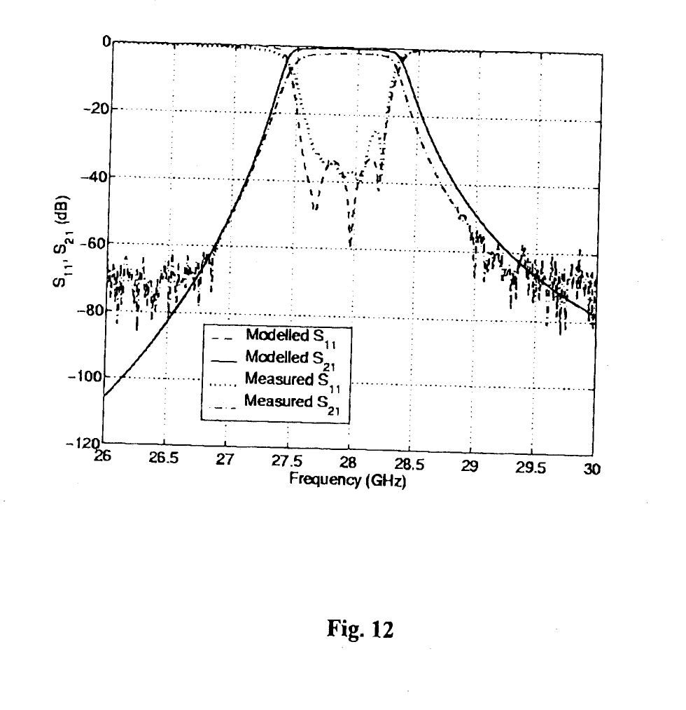

FIG. 12 shows the measured response after tuning compared with the modelled response using the designed dimensions given in section III. The center frequency has been successfully tuned, and the shape of the response is still quite close, however, the bandwidth has been reduced.

IV. Dielectric Tuning Element and Technique

The tuning technique in accordance with the embodiments of the invention may involve inserting a piece of dielectric down the entire length of an assemble E-plane filter to tune simultaneously all resonators. The size and placement of the piece of dielectric are determined by the amount of frequency shift required. Use of this dielectric tuning technique requires the filter to be designed at a higher frequency than is required, so that with tolerances the frequency either is exactly correct, or requires tuning down in frequency, as the dielectric decreases the center frequency. This tuning technique is suitable for mass production under computer control.

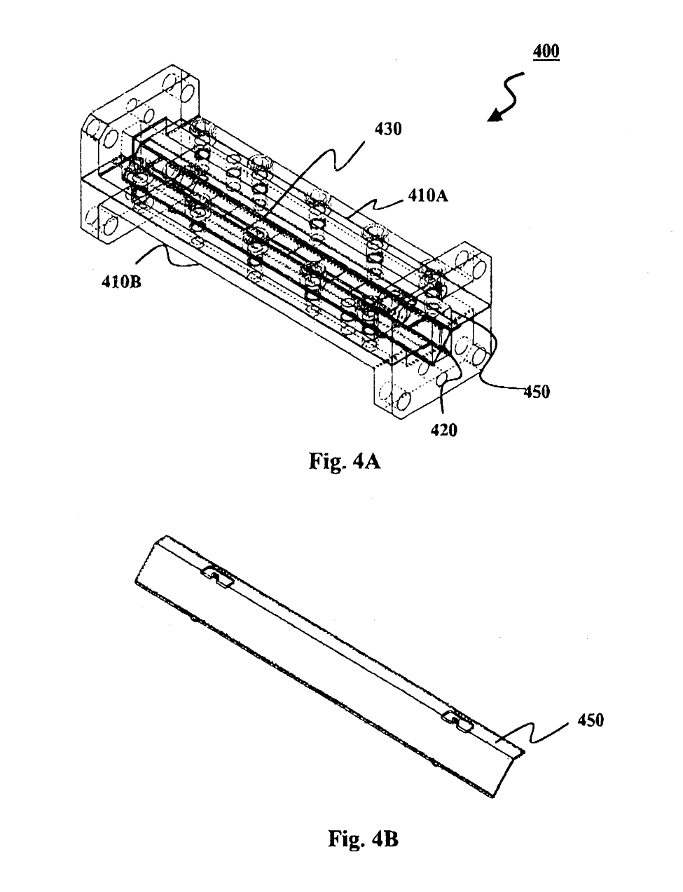

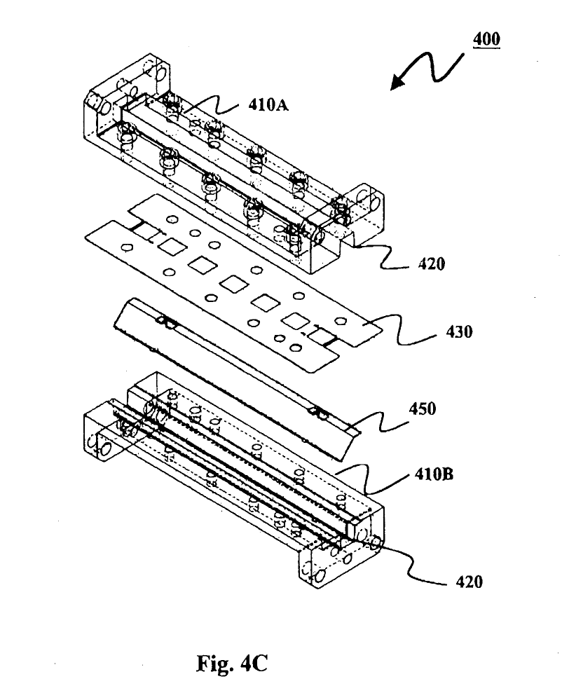

FIGS. 4 to 9 illustrate several differently shaped dielectric tuning elements, which can be used with an assembled waveguide filter, in accordance with the embodiments of the invention. Examples of where the dielectric tuning element can be inserted into the waveguide cavity include:

a) an angled dielectric tuning element 450 inserted diagonally across one or both halves of the waveguide (one half is shown in FIG. 4);

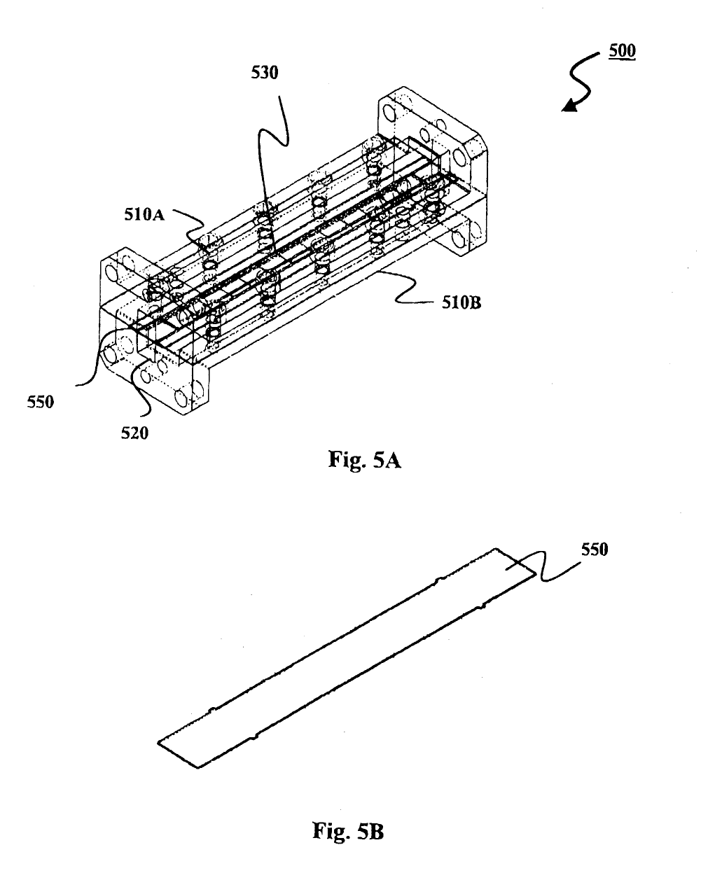

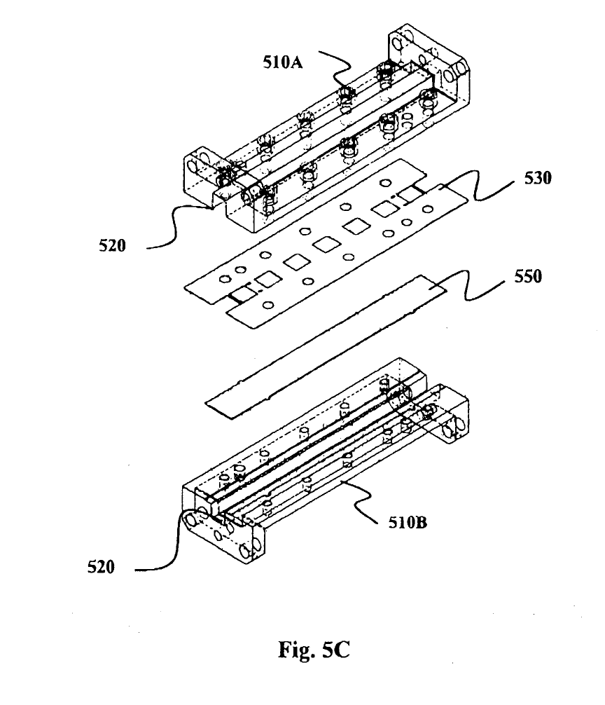

b) a flat, rectangular dielectric tuning element 550 inserted directly down the centre of the waveguide parallel to the septum on one or both sides (one side is shown in FIG. 5);

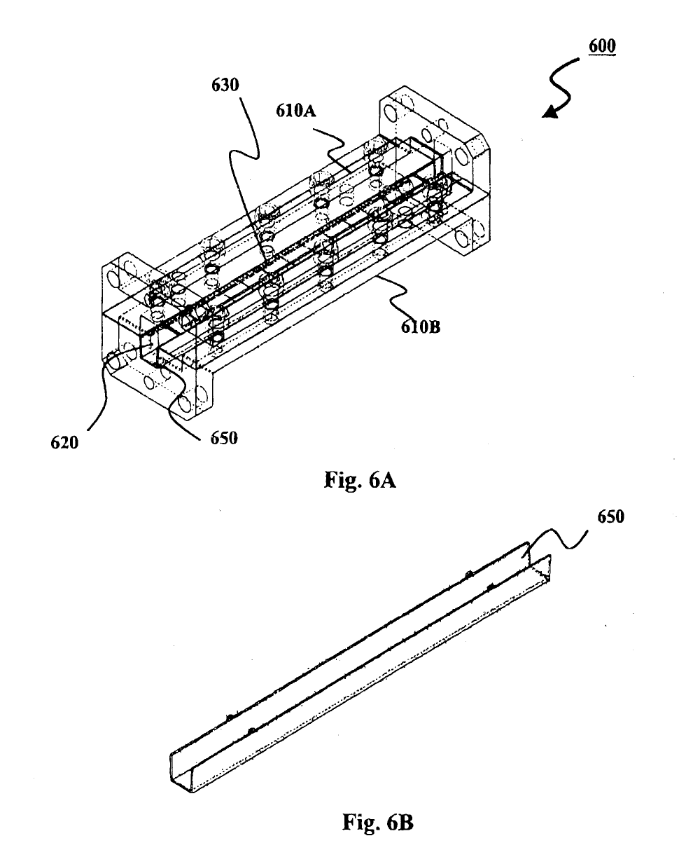

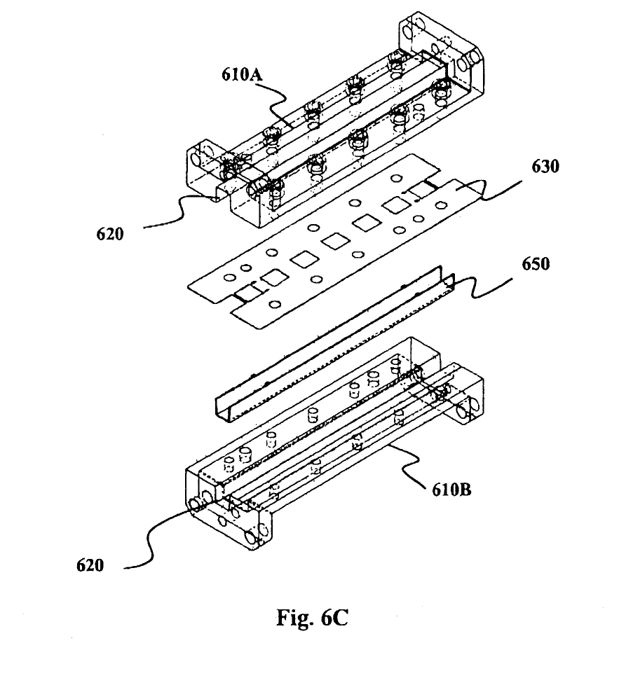

c) a U-shaped dielectric tuning element 650 inserted into the waveguide and making contact with the side walls and back wall of one half, or both halves, of the waveguide (one half is shown in FIG. 6);

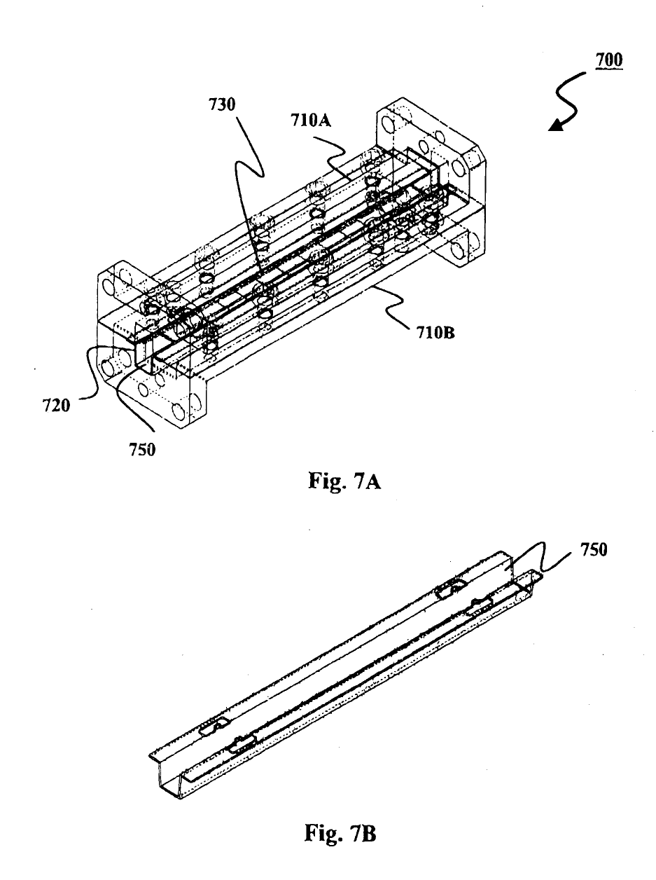

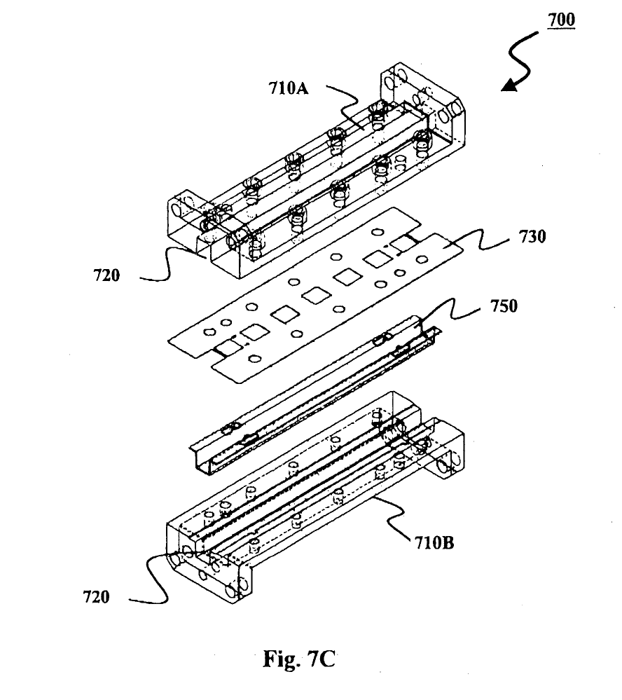

d) a U-shaped dielectric tuning element 750 with flanges on opposite sides inserted into the waveguide and making contact with the side walls and back wall of one half, or both halves, of the waveguide (one half is shown in FIG. 7);

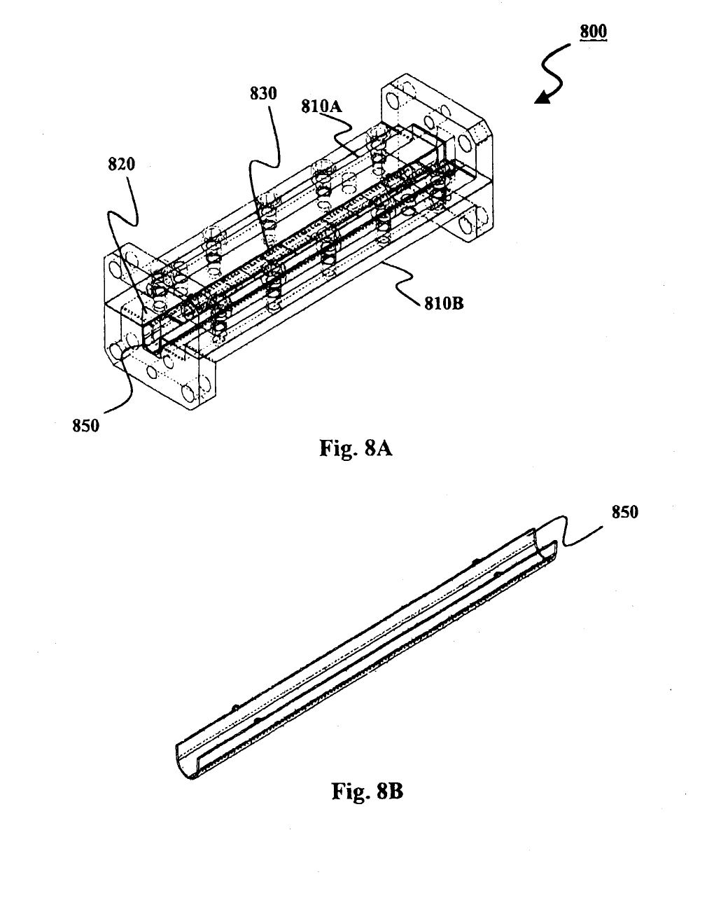

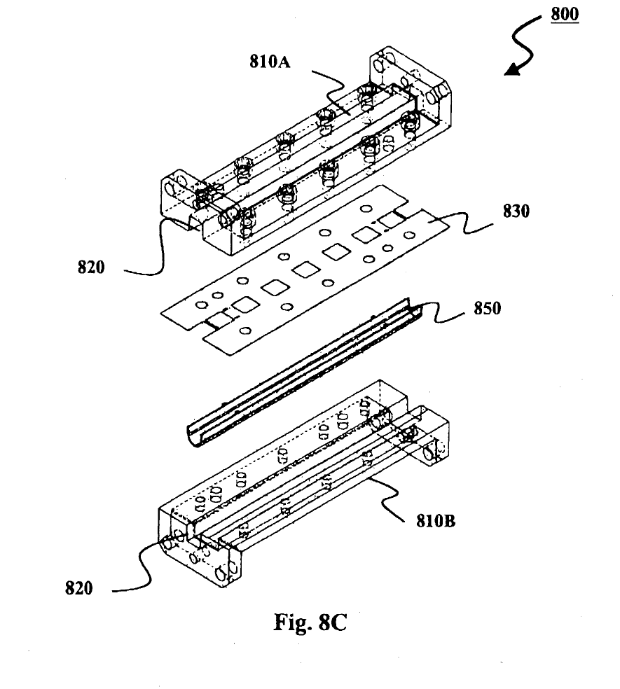

e) a curved U-shaped dielectric tuning element 850 inserted into either one half or both halves of the waveguide (one half is shown in FIG. 8), and

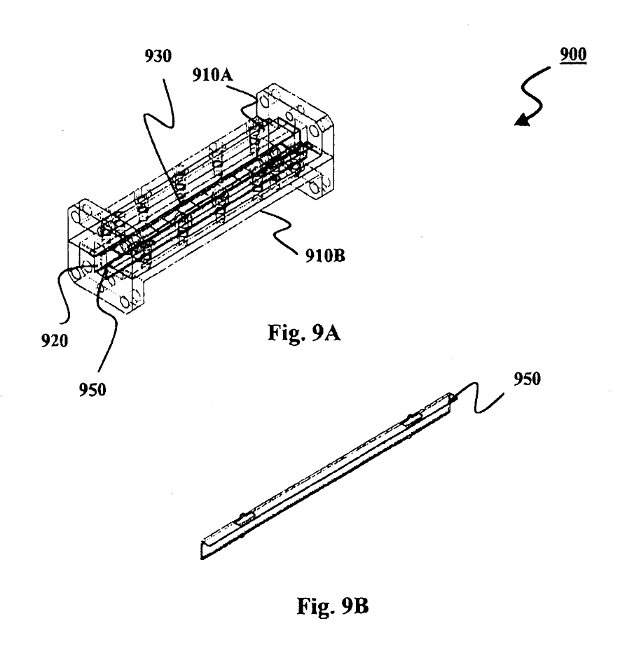

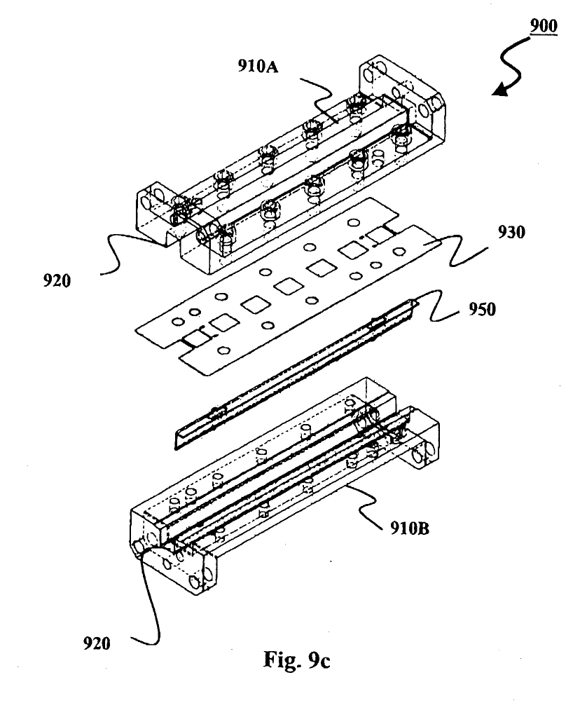

f) an L-shaped dielectric tuning element 950 inserted down 1, 2, 3 or all of the waveguide walls such that the dielectric is perpendicular to the septum (a dielectric tuning element inserted down 1 wall only is shown in FIG. 9).

The dielectric tuning element is preferably elongate in shape to sit in or complement the elongated waveguide cavity. It will be appreciated by those skilled in the art in view of this disclosure that different proportions including lengths and thicknesses for the dielectric tuning element may be used without departing from the scope and spirit of the invention.

FIGS. 4A, 4B, and 4C show an assembled filter 400 with the dielectric tuning element 450 inserted diagonally in the waveguide cavity 420, the angled L-like dielectric tuning element 450, and an exploded view of the filter 400 and dielectric tuning element 450, respectively. The waveguide filter 400 includes two matching waveguide members 410A, 410B, which when assembled form flanges at each end of the waveguide 410. Also, each waveguide members 410A, 410B has a groove or slot in a side, so that when the waveguide members 410A, 410B are assembled the waveguide cavity 420 is formed. As shown in FIG. 4C, a single septum 430 is practiced which has seven cavities or windows punched in a central region of the septum 430 leaving two flange areas for placement between the waveguide members 410A, 410B and proper alignment. The substantially L-shaped dielectric tuning element 450 has two openings in the smaller leg of the “L” near opposite ends of that element 450. At the crease formed by the angled tuning element and within a respective opening is a tab projecting, which preferably engages a matching hole in the septum 450. Two other tabs extend from the opposite side of the larger leg of the “L”, which can likewise connect with holes in the waveguide housing 410. It will be appreciated by those skilled in the art in the light of this disclosure that the noted tabs are merely preferments in this and the following embodiments and may be omitted or varied without departing from the scope and spirit of the invention. The same applies to the noted openings. Both features are for the sole purpose of alignment and securing the dielectric tuning element.

FIGS. 5A, 5B, and 5C show an assembled filter 500 with the dielectric tuning element 550 inserted directly down the centre of the waveguide parallel to the septum 530, the flat, rectangular dielectric tuning element 550, and an exploded view of the filter 500 and dielectric tuning element 550, respectively. Elements of FIG. 5 that are the same or similar to features described with reference to FIG. 4 have similar numbering (e.g. filter 400 in FIG. 4 and filter 500 in FIG. 5), and the description of the same features is not set forth to avoid repetition. The same principle applies to the remaining drawings. The flat, rectangular dielectric tuning element 550 has two tabs on both lengthwise opposite sides (4 tabs total), each adjacent the end lengthwise of the element 550. The tabs can be aligned with corresponding grooves in the waveguide bodies 510A and 510B to secure the dielectric.

FIGS. 6A, 6B, and 6C show an assembled filter 600 with the dielectric tuning element 650 inserted in the waveguide cavity 620, a U-shaped dielectric tuning element 650 inserted into the waveguide cavity 620 and contacting side walls and a back wall of the waveguide member 610B, and an exploded view of the filter 600 and dielectric tuning element 650, respectively. Each wall or elongated portion of the dielectric tuning element 650 is substantially perpendicular to the adjoining wall, so that the tuning element 650 fits snugly in a portion of the rectangularly shaped cross-section of the waveguide cavity 620. Similar to the dielectric tuning element 550 of FIG. 5, the U-shaped tuning element 650 preferably has four tabs, two protruding from each edge of a parallel wall of the “U” Again those tabs can preferably engage matching grooves in the septum 630 to secure the dielectric.

FIGS. 7A, 7B, and 7C show an assembled filter 700 with the dielectric tuning element or member 750 inserted directly into the waveguide cavity next to the septum 730, a U-shaped dielectric tuning element 750 inserted into the waveguide cavity 720 and contacting side walls and a back wall of the waveguide member 710B, and an exploded view of the filter 700 and dielectric tuning element 750, respectively. The dielectric tuning element 750 is substantially similar in construction to the tuning element 650 of FIG. 6, but the dielectric tuning element 750 further has two flanges with tabs and openings similar in construction as those of tuning element 450 of FIG. 4. Similar to the dielectric tuning element 550 of FIG. 5, the U-shaped tuning element 650 preferably has four tabs, two projecting from each edge of a parallel wall of the “U”. Each flange extends substantially perpendicularly from an adjoining parallel wall of the “U”. Again those tabs can preferably engage matching grooves in the septum 730.

FIGS. 8A, 8B, and 8C show an assembled filter 800 with the dielectric tuning element 850 inserted in the waveguide cavity 820, a rounded or curved U-shaped dielectric tuning element 850 inserted into the waveguide cavity 820 and substantially contacting side walls and contacting at least a point in a back wall of the waveguide member 810B, and an exploded view of the filter 800 and dielectric tuning element 850, respectively. The base of the “U” is rounded for this tuning element 850. Similar to the dielectric tuning element 650 of FIG. 6, the U-shaped tuning element 850 preferably has four tabs, two projecting from each edge of a parallel wall of the “U”.

FIGS. 9A, 9B, and 9C show an assembled filter 900 with the dielectric tuning element 950 inserted down 1, 2, 3 or all of the waveguide walls such that the dielectric is perpendicular to the septum, the L-shaped dielectric tuning element 950, and an exploded view of the filter 900 and dielectric tuning element 950, respectively. The L-shaped dielectric tuning element 950 preferably has two openings in the smaller leg of the “L” near opposite ends of that element 950. At the crease of the “L” of the tuning element and within a respective aperture is a projecting tab. Two other tabs preferably extend from the opposite side of the larger leg of the “L”. The tabs are aligned with matching grooves in the waveguide and septum to secure the dielectric.

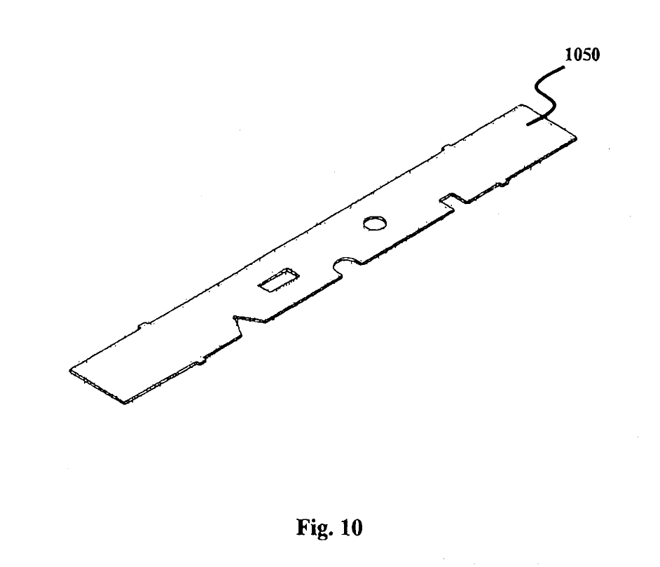

FIG. 10 shows examples of how the dielectric tuning element 1050 of FIG. 5 may be stamped to form various sized and shaped apertures or re-entrant features to tune individual resonator and coupling elements. The stamping is preferably performed by punching a section from the edge of the dielectric where the depth of the punched section determines the required tuning. However, the stamping may also be performed using apertures of varying size and shape.

The tuning structure with the dielectric placed down the centre of the waveguide parallel and in contact with the septum (FIG. 5) is the most sensitive of those shown. The dielectric in this configuration is in the centre of the maximum of the electric field and so has the most affect on the response. By moving the dielectric away from the maximum field, the dielectric properties do not need to be as tightly controlled and the loss due to the dielectric will also not be as high. The tuning structure shown in FIG. 5 has the further disadvantage of reducing the %bandwidth of the filter at the same time as shifting the frequency down. Whereas the structures shown in FIGS. 6 and 7 shift the frequency while leaving the % bandwidth unchanged.

The embodiments of the invention enable low-cost tuning and manufacturing of E-plane millimeter-wave filters. The increased tolerances on the dimensions of filter elements have the main effect of changing the frequency of response, and not the actual shape of the response. This lends itself to a low-cost dielectric tuning technique to compensate for the frequency shifts.

An E-plane waveguide filter used in millimeter-wave bands, a tuning element for such an E-plane waveguide filter, and methods of making and tuning an E-plane waveguide filter used in millimeter-wave bands have been described. It will be apparent to those skilled in the art, in the light of this disclosure, that modifications and/or changes can be made to the embodiments described without departing from the scope and spirit of the invention.

The claims defining the invention are as follows:

1. A method of tuning an E-plane waveguide filter, said method including the steps of:
testing filter characteristics of said filter, said filter including at least two waveguide members and at least one septum assembled together, each waveguide member having a shaped surface formed in said waveguide member to provide a waveguide cavity when said waveguide members are assembled, said at least one septum disposed in said waveguide cavity; and
inserting a dielectric tuning member into said waveguide cavity of said assembled filter to adjust at least one frequency characteristic of said filter dependent upon said tested filter characteristics.

2. A method of making an E-plane waveguide filter, said method including the steps of:
assembling at least two waveguide members with at least one septum in a waveguide cavity, each waveguide member having a shaped surface formed in said waveguide member to provide said waveguide cavity when said waveguide members are assembled; and
inserting a dielectric tuning member into said waveguide cavity to adjust at least one frequency characteristic of said filter for said assembled waveguide members and at least one septum.

3. The method according to claim 1 or claim 2, wherein said at least one septum is solid metal or metal patterned on a dielectric substrate (finline).

4. The method according to claim 1 or claim 2, wherein said at least one septum is patterned to form resonant elements within said waveguide cavity.

5. The method according to claim 2, further including the step of testing filter characteristics of said assembled waveguide members and said at least one septum prior to said inserting step.

6. The method according to claim 1 or claim 5, further including the step of forming said dielectric tuning member in response to said tested filter characteristics.

7. The method according to claim 1 or claim 2, wherein said dielectric tuning member is patterned to adjust resonant elements within said waveguide cavity.

8. The method according to claim 7, wherein said patterned dielectric tuning member has apertures or re-entrant features formed in said dielectric tuning member.

9. The method according to claim 1 or claim 2, wherein the dielectric material of said dielectric tuning member includes low cost stampable plastic, such as polyethylene.

10. The method according to claim 1 or claim 2, wherein said dielectric tuning member has an elongated body.

11. The method according to claim 10, wherein said elongated body has a cross-sectional shape selected from the group of shapes consisting of: an angled or bent shape, a flat and rectangular shape, a U-shape, a U-shape with flanges, a rounded or curved U-shape, and an L-shape.

12. The method according to claim 1 or claim 2, including the step of fineblanking at least one septum blank to form said at least one septum.

13. The method according to claim 1 or claim 2, further including the step of die-casting said at least two waveguide members.

14. The method according to claim 1 or claim 2, further including the step of machining said at least two waveguide members.

15 The method according to claim 1 or claim 2, wherein said adjusting step includes shifting down a frequency response of said filter

16. An E-plane waveguide filter, said filter including:
at least two waveguide members, each waveguide member having a shaped surface formed in said waveguide member to provide a waveguide cavity when said waveguide members are assembled;
at least one septum located in said waveguide cavity; and
a dielectric tuning member inserted in said waveguide cavity of said assembled filter to adjust at least one frequency characteristic of said filter dependent upon tested filter characteristics.

17. The filter according to claim 16, wherein said at least one septum is metal or finline.

18. The filter according to claim 16, wherein said at least one septum is patterned to form resonant elements within said waveguide cavity.

19. The filter according to claim 16, wherein said dielectric tuning member is formed in response to tested filter characteristics of said at least two assembled waveguide members and said at least one septum prior to insertion of said dielectric tuning member in said waveguide cavity.

20. The filter according to claim 16, wherein said dielectric tuning member is patterned to adjust resonant elements within said waveguide cavity.

21. The filter according to claim 20, wherein said patterned dielectric tuning member has either apertures or reentrant features formed in said dielectric tuning member.

22. The filter according to claim 16, wherein the dielectric material includes low-cost stampable plastic, such as polyethylene.

23. The filter according to claim 16, wherein said dielectric tuning member has an elongated body.

24. The filter according to claim 23, wherein said elongated body has a cross-sectional shape selected from the group of shapes consisting of: an angled or bent shape, a flat and rectangular shape, a U-shape, a U-shape with flanges, a rounded or curved U-shape, and an L-shape.

25. The filter according to claim 16, wherein said at least one septum is formed by fineblanking at least one septum blank.

26. The filter according to claim 16, wherein said at least two waveguide members are die-cast.

27. The filter according to claim 16, wherein said at least two waveguide members are machined.

28. A tuning member for an E-plane waveguide filter, said filter including at least two waveguide members and at least one septum, each waveguide member having a shaped surface formed in said waveguide member to provide a waveguide cavity when said waveguide members are assembled, said at least one septum disposed in said waveguide cavity, said tuning member including:
a dielectric member for adjusting at least one frequency characteristic of said filter when inserted into said waveguide cavity, said dielectric member formed in response to tested frequency characteristics of said filter for the assembled waveguide members and at least one septum.

29. The tuning member according to claim 28, wherein said at least one septum is metal or finline.

30. The tuning member according to claim 28, wherein said at least one septum is patterned to form resonant elements within said waveguide cavity.

31. The tuning member according to claim 28, wherein said dielectric member is formed in response to tested filter characteristics of said at least two assembled waveguide members and said at least one septum prior to insertion of said dielectric tuning member in said waveguide cavity.

32. The tuning member according to claim 28, wherein said dielectric member is patterned to adjust resonant elements within said waveguide cavity.

33. The tuning member according to claim 32, wherein said patterned dielectric member has apertures formed in said dielectric member.

34. The tuning member according to claim 28, wherein the dielectric material includes low-cost stampable plastic, such as polyethylene.

35. The tuning member according to claim 28, wherein said dielectric member has an elongated body.

36. The tuning member according claim 35, wherein said elongated body has a cross-sectional shape selected from the group of shapes consisting of: an angled or bent shape, a flat and rectangular shape, a U-shape, a U-shape with flanges, a rounded or curved U-shape, and an L-shape.

37. The tuning member according to claim 28, wherein said at least one septum is formed by fineblanking at least one septum blank.

38. The tuning member according to claim 28, wherein said at least two waveguide members are die-cast.

39. The tuning member according to claim 28, wherein said at least two waveguide members are machined.

40. A method of tuning an E-plane waveguide filter, said method substantially as hereinbefore disclosed with reference to any one or more of FIGS. 4-9 of the accompanying drawings.

41. A method of making an E-plane waveguide filter, said method substantially as hereinbefore disclosed with reference to any one or more of FIGS. 4-9 of the accompanying drawings.

42. An E-plane waveguide filter, said filter substantially as hereinbefore disclosed with reference to any one or more of FIGS. 4-12 of the accompanying drawings.

43. A tuning member for an E-plane waveguide filter, said filter including at least two waveguide members and at least one septum, each waveguide member having a shaped surface formed in said waveguide member to provide a waveguide cavity when said waveguide members are assembled, said at least one septum disposed in said waveguide cavity, said tuning member substantially as hereinbefore disclosed with reference to any one or more of FIGS. 4-12 of the accompanying drawings.
